(19) United States
(12) Patent Application Publication
(10) Pub. No.: US 2003/0190137 A1
(43) Pub. Date: Oct. 9, 2003

(54) Method and system for backing up and restoring large data storage media using a digital video tape

(76) Inventor: Mark D. Pesce, Los Angeles, CA (US)

Correspondence Address: MARK D. PESCE, 8323 Lookout Mountain Ave., LOS ANGELES, CA, 90046, US

(21) Appl. No.: 10/105,023

(22) Filed: Mar. 21, 2002

(51) Int. Cl. H04N 5/76; H04N 5/225

(52) U.S. Cl. 386/46; 386/117

(57) ABSTRACT

Methods, systems, and computer program products are disclosed for enabling the backup of very large volumes of data from a computer hard drive to a digital tape contained in a DV camcorder and for restoring the same data from the tape to the hard drive. The process uses the IEEE-1394 standard referred to commercially as FireWire. A backup/restore software component is installed on the host computer (i.e., the computer having the hard drive to be backed up) and enables the computer to communicate over a FireWire cable with a DV camcorder. Through this process, entire hard drives containing in the order of 30-40 gigabytes of data, can be backed up to a low number of inexpensive digital tapes. In many cases, where the total amount of data is less than 20 gigabytes, only one mini DV tape, for example, may be needed. The backup is performed quickly by virtue of the extremely high-speed data transmission capabilities of FireWire and the data on the tape can be randomly accessed.

### BACKGROUND OF THE INVENTION

1. Field of the Invention

The present invention relates generally to computer software and non-computer-related peripheral devices. More specifically, it relates to computer hard drive or large storage media backup and restore processes using a digital video camcorder or similar device and mini digital video tapes or similar storage media.

2. Discussion of Related Art

Many home computers today come equipped with hard disk drives that can store as much as 30 gigabytes of data or more. Some capable of storing 100 gigabytes are not unheard of, even for home use. As prices of hard disk drives drop, computer manufacturers wanting to maintain a competitive edge will continue to offer higher capacity disk drives. Increasingly often, computer users are storing a plethora of valuable and irreplaceable information on their computers, ranging from medical and financial data, tax documents, photos, digital films, a wide variety of end-user applications, networking software, files from work or relating to a home business or private practice, games, and so on. Many individuals are using their home computers for businesses as well, keeping valuable client and customer data on their home hard drives. Information which, if lost, could create serious liability for the user. Many applications are taking up more space on hard drives and certain data files, such as movies, music, e-mail, educational materials, such as encyclopedias, and games, to name a few examples.

Presently, there are numerous ways to back up and restore a hard drive. However, not many of them are practical or technically reliable for backing up very large volumes of data after a catastrophic failure, computer malfunction, virus attack, or other unforeseen accidents. Corporations and large entities typically use tapes to back up its enterprise databases and other data. For such entities, maintaining hundreds of gigabytes or even terabytes of data, this is the most efficient way of creating back-ups in an organized and structured manner. This is essential if data is to be restored so it can be used accurately and efficiently in a business setting. Tapes are one option and can be used inexpensively to back up and restore large volumes of data. Typically, with such tapes, random access to data is not available and is generally not needed.

For the home computer user or the small business computer user employing a database server or web server, who does not have terabytes or hundreds of gigabytes of data to back up, there are numerous options for backing up a hard drive. However, none of these options presently offer an inexpensive and fast back-up mechanism for volumes greater than 4.7 gigabytes. The few that allow back-ups of larger volumes of data require the user to purchase separate peripheral devices.

As mentioned, many hard drives presently store 30 gigabytes of data and some up to 100 gigabytes. In the future computers will have even greater storage capacity. As the data on a hard drive accumulates, creating back-ups of the data will be increasingly important. Yet, it is likely that the individual home or small business user will be more lackadaisical and less rigorous about backing up the data, primarily because the greater the volume of data, the more difficult and cumbersome it becomes to maintain the data. The time it takes to back up the hard drive grows to the point where it is inconvenient for the user, or becomes too expensive in terms of storage media, e.g., CD-ROMs, which the user needs to purchase and keep track. In addition, organizing the back-up data in a manner that makes restoring the data after a failure practical requires a fairly high degree of technical know-how and may require an increased sophistication than many home users have or, more significantly, are willing to learn.

For example, presently, many home users or small business owners use Iomega's Zip Drive or Pinnacle to back up their hard drives. In these cases the data is transferred to a separate and portable hard drive, essentially a distinct piece of hardware that is maintained separately from the computer. Other methods include using CD-ROMs, DVD-RAMs, and other optical storage media. A typical CD-ROM can store up to 700 megabytes of data and, using current technology, takes about 4 minutes to fill. Thus, a 13 gigabyte hard drive would require about 18 CDs, take several hours, and require lots of user intervention, e.g., inserting and removing CD-ROMs. As noted, in many of these cases the home computer user needs to purchase a separate piece of hardware and numerous individual CDs or other storage media to store the data. In addition, the user typically needs a SCSI cable for transferring the data from the computer to the separate hard drive, which are bulky and inconvenient to use. In addition, the extra hardware is costly, often in the range of several hundreds of dollars and purchasing additional back-up media can also be costly.

What is needed is software for backing up a large hard drive that is easy and inexpensive and does not require that the user purchase additional hardware. Furthermore, the software or processes should take advantage of consumer electronics already owned by the computer user and utilize a data transfer standard/protocol that is robust and has gained widespread acceptance. The process should require minimal user intervention and monitoring during the back up process. Finally, the method should use digital storage media highly suitable for storing massive amounts of data and capable of some degree of random access.

### SUMMARY OF THE INVENTION

In one aspect of the present invention, a method of backing up data on a storage medium, such as a computer hard drive, using a digital video camcorder containing a digital tape is described. The computer or device containing the storage medium first detects whether a camcorder is connected to the computing device, wherein the connection between the computer and digital camcorder is an IEEE-1394 connection. A backup process is then initiated by invoking an application on the computer, at which time file directory information is transmitted to the digital tape in the digital video camcorder. Once the application is invoked, data is transmitted from the computer to the digital video camcorder.

In another aspect of the present invention, a method of transmitting data from a computer hard drive to a storage device is described. A software module for backing up data collects directory data from a computer hard drive. A camcorder is powered on and a digital tape is inserted. The data from the hard drive is then processed in order to make the data suitable for transmission over an IEEE-1394 connection to the camcorder. Once the data is transferred to the camcorder, it is stored on the digital tape.

In yet another aspect of the present invention, a method of transmitting data from a digital video camcorder to a computer is described. Data of any type is retrieved from a digital tape in a camcorder. The data is then transmitted over an IEEE-1394 connection to a computer. In yet another aspect of the present invention, a method of creating a backup of a hard drive in a computer using a digital camcorder containing a digital tape is described. A computer is connected to a digital camcorder using an IEEE-1394 connection. A back up program on the computer is then invoked thereby causing data of any type to be transmitted from the hard drive of the computer to the digital tape using the IEEE-1394 protocol.

### BRIEF DESCRIPTION OF THE DRAWINGS

The invention will be better understood by reference to the following description taken in conjunction with the accompanying drawings in which:

FIG. 1 is a diagram of host computer, a FireWire cable, and a miniDV camcorder, containing a mini DV tape in accordance with one embodiment of the present invention.

FIG. 2 is a block diagram showing components of the back up and restore system in accordance with one embodiment of the present invention.

FIG. 3 is a diagram of firmware and software residing on the computer needed for operating the back up and restore system in accordance with one embodiment of the present invention.

FIG. 4 is a logical block diagram of components on a host computer equipped with FireWire used in one accordance with one embodiment of the present invention.

FIGS. 5A through 5C are flow diagrams of a process of using the backup/restore software component, FireWire, and a DV camcorder to back up data on a computer hard drive in accordance with one embodiment of the present invention.

FIG. 6 is a flow diagram of a process of using the backup/restore software component, FireWire, and a DV camcorder to restore data to a computer hard drive from a digital tape using a DV camcorder in accordance with one embodiment of the present invention.

### DETAILED DESCRIPTION

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

It is estimated that by 2005 there will be approximately 68 million digital video camcorders, such as Digital8, miniDV and DVCAM, sold in the consumer market in the United States alone. Most digital video camcorders will be equipped with a IEEE-1394 standard interface, referred to as a FireWire connection, a high-speed data transfer protocol which facilitates rapid communication between a peripheral device and a computer. The standard is discussed in great detail at www.1394TA.org. As it happens, many PCs and Macintoshes sold today have FireWire ports, a trend set by Apple for its Macintosh computers in 1998. A thin, light-weight, and widely available cable (a “FireWire cable”) connects the computer with a peripheral device, such as a DV camcorder. Other devices having a FireWire interface include hard drives. Most home computers manufactured by Sony are now FireWire enabled.

The present invention is a software application that enables data from a hard drive or other source to be transferred between a computer and a digital video camcorder using a FireWire port or comparable high-speed data connection, such as a USB 2.0 connection. The application harnesses the significant digital storage capabilities of digital tapes, such as miniDV, Digital8, and DVCAM tapes, used in digital video (“DV”) camcorders and allows the tapes and camcorders to be used as a digital backup system by connecting a personal computer and a DV camcorder using a FireWire cable. For example, a miniDV tape can store up to 17.5 GB per tape, exceeding the storage capacity of DVD-RAMs and, by orders of magnitude, the storage capacity of CD-ROMs, the most popular storage solutions presently in the market. Many computers now have 30 GB or more hard drives which make it difficult for users to make complete back ups of their hard drives.

A method and system of backing up and restoring a hard drive are described in the various figures. The present invention is a software component that is a cross-platform utility program that allows FireWire (IEEE-1394 ) equipped DV camcorders and digital tapes to be used as high-capacity digital back up and restore devices for use with FireWire-ready computers. In other preferred embodiments of the present invention, other high-speed transmission protocols, such as USB 2.0, can be used. The present invention allows a user to make an entire, contiguous copy of the data on their 30 gigabyte hard drive with a few simple commands and using one or two tapes rather than dozens of CD-ROM or several DVD-RAM disks.

Because FireWire was designed for significant high-speed data transmission (400 megabits/second), a complete back up of a 30 GB hard disk would take as little as one hour and require not more than two tapes, at a cost of about $10. This is in contrast to using approximately 50 CD-ROMs ($25) or 7 DVD-RAMs ($150) and taking several hours to “burn” the data on the disks. Many home computer users are not in the habit of making entire back-ups of their hard drives. As the size of hard drives grows to volumes up to 70 or 80 gigabytes, the need to back up will be even more critical yet users will be less likely to do so due to the inconvenience and cost of backing up such large volumes of data. Present methods are not conducive to making back ups of entire hard drives; they require extra hardware, purchasing CD-ROMs or other optical storage to store the data, and so on. The present invention allows a user to avoid purchasing extraneous hardware yet make complete back ups of entire hard drives quickly on one or two digital tapes, such as miniDV tapes, using equipment the user already owns. This makes it practical for a user to make multiple back-ups of an entire hard drive, thereby allowing the user to keep the back-ups in various locations.

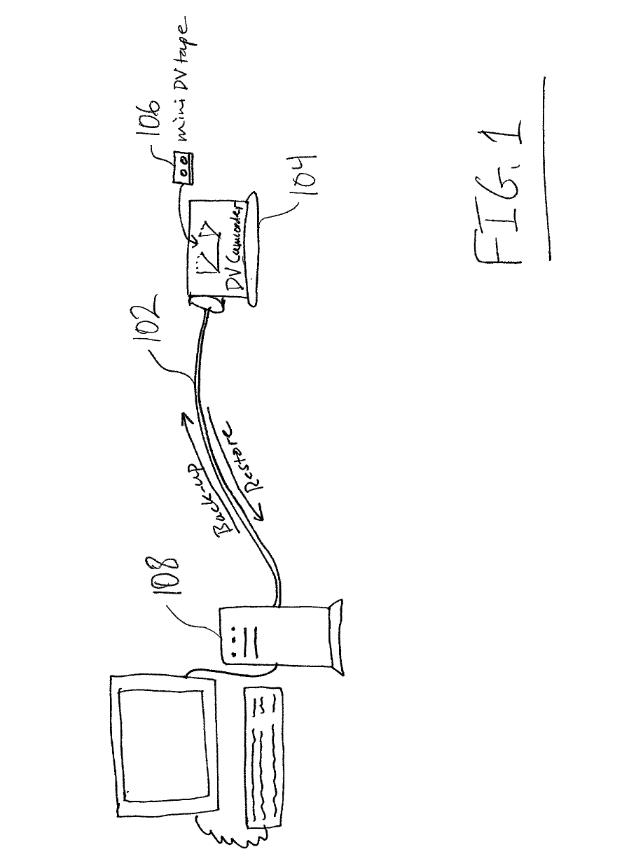

As shown in FIG. 1, a user obtains a FireWire cable 102 (a light-weight, four-point cord) and connects, in this example, a miniDV camcorder 104, containing a mini DV tape 106, to a personal computer 108. In other examples, a Digital8 camcorder or DVCAM, and Digital8 tape or DVCAM tape, respectively, can be used. Both devices have FireWire ports, increasingly a common feature for home computers and present on nearly all digital camcorders. Data may then be transmitted from the computer hard drive to the camcorder and onto the tape. A 60-minute tape can store about 13.5 gigabytes and a 80-minute tape about 17.5 gigabytes of data. When the hard drive needs to be restored, the entire contents of the tape or tapes are sent to the hard drive via the same FireWire cable 102. The user activates the FireWire back-up/restore system by invoking an application on the computer after connecting the computer to the camcorder using the FireWire connection.

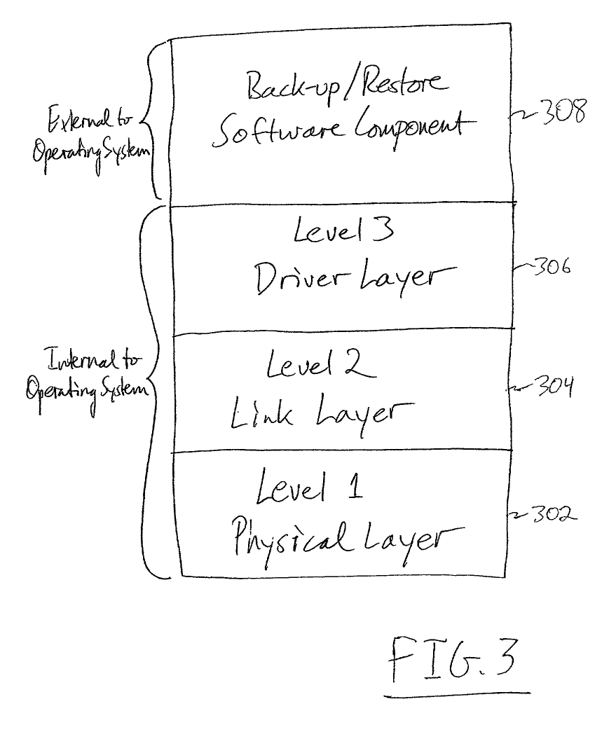

FIG. 2 is a block diagram showing components of the back up and restore system in accordance with one embodiment of the present invention. A computer 202 having a FireWire port 204 capable of transmitting 400 megabits/second is executing the back-up software 206 of the present invention. Computer 202 can be any type of computer including a PC or an Apple computer, such as a Macintosh, Sun workstation, Linux workstation, and other Unix-based workstations and computers. In addition, computing device 202 can be a video game console, such as a Sony Play Station, or any other device having a large data storage capacity, such as television recording units, including TiVo and Replay. A FireWire cable 208 between the computer and a DV camcorder 210 is typically a four-point or six-point cable that allows for significant high-speed transmission of data between the two components or nodes. In another embodiment, a USB 2.0 cable can be used between computer 202 and DV camcorder 210 for significant high-speed transmission of data.

DV camcorder 210 has a FireWire port 212. The camcorder contains a tape 214 capable of holding about 13.5 gigabytes of uncompressed data. This data can be visual/audio data or normal data. Such tapes are capable of holding up to 25 gigabytes of data, depending on the compression of the data. Camcorder 210 also contains certain firmware 216, such as Camera Control Specification 1.30, further described at www.1394TA.org, a standard developed by the camcorder industry to allow its products to communicate with computers. Firmware 216 also allows camcorders to receive commands from a computer and to respond to them. The Camera Control Specification firmware is necessary for the FireWire capabilities of the camcorder to be useful with regard to sending and receiving data and commands from computers.

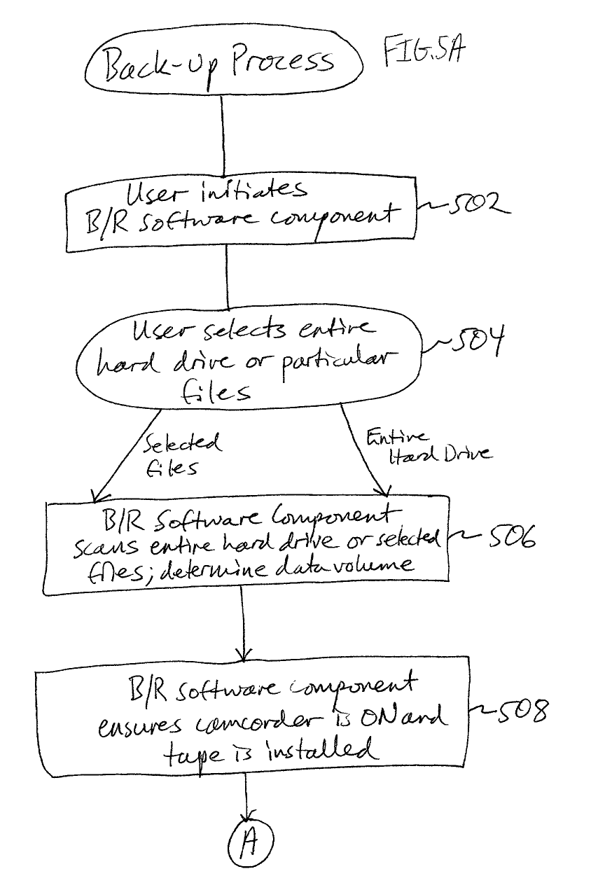

FIG. 3 is a diagram of firmware and software residing on the host computer needed for operating the back-up and restore system in accordance with one embodiment of the present invention. In the preferred embodiment, the interface levels and software described reside on the computer or other device, such as a video game console or television recording device, controlling the hard drive being backed up. At Level 1, physical layer 302, bits are sent and received over the FireWire port. Level 2 is a link layer 304 that establishes the link for the FireWire connection and resides above physical layer 302. Level 3 is a driver layer 306 that controls the transmission and receiving of commands and data packets between a camcorder and computer. They reside in the operating system of the computer, for example, in Windows 98/ME/2000/XP, MacOS, a Unix-based operating system, such as Linux or Solaris, among others. In the Windows context, these layers are referred to as OHCI, and is known to one of ordinary skill in the field of computer programming.

Residing above these layers and outside the computer operating system is a backup/restore software component 308 of the present invention. This software component allows the computer hard disk drive to communicate with the DV camcorder and is described in greater detail below. The backup/restore software component is described in greater detail in the figures below.

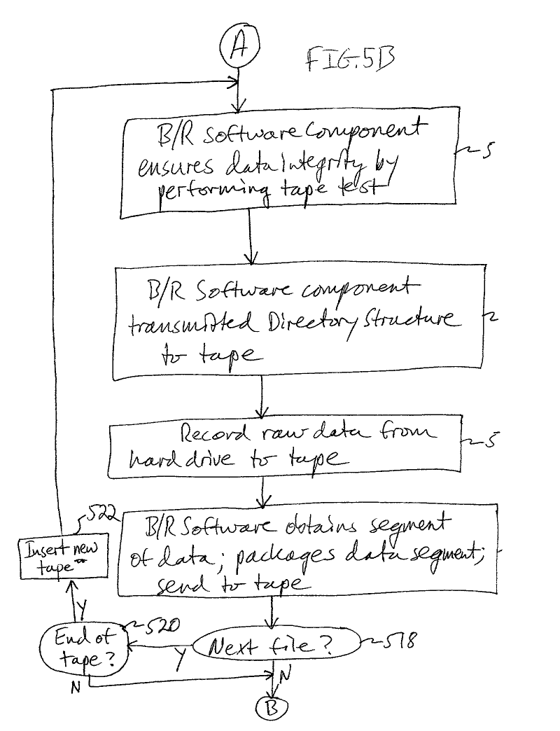

FIG. 4 is a logical block diagram of components on a host computer equipped with FireWire used in accordance with one embodiment of the present invention. Data stored on a computer hard drive is in communication with back-up/restore software component 404. When a back-up command is initiated on the host PC, data on the hard drive is first transmitted 406 to software component 404. Software component 404 packages the data by inserting error correction codes, performing compression, inserting headers, inserting cyclic redundancy codes (CRC's) and the like. Such packaging of data before transmission over various types of links is known in the field of computer programming. The back-up/restoreSoftware component also inserts particular commands, for example, rewind, record, receive data, stop, and so on. This command data coupled with the actual raw data from the hard drive comprise a Command and Data Stream 408 in accordance with IEEE-1394. This data stream is then sent to a FireWire port 410 and transmitted over a FireWire 412 cable to a DV camcorder 414.

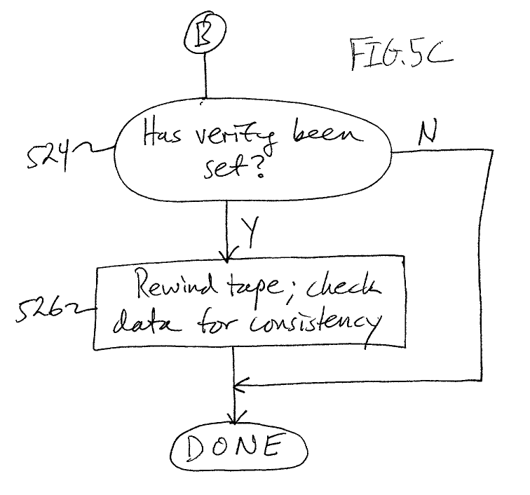

FIGS. 5A, 5B, and 5C are flow diagrams of a process for using the backup/restore software component, FireWire, and a DV camcorder to back up data on a computer hard drive in accordance with one embodiment of the present invention. At step 502 the user has already installed the back-up/restore software component on the host computer and has a wizard on the computer that allows him to initiate the back-up process. The user initiates the process by invoking the software component. In one embodiment, this can be done by clicking on an icon on the desktop.

At step 504 the user decides whether only certain files or the entire contents of the drive will be backed up. The user is presented with a high-level list of all the files or directories on the hard drive and is given the option of selecting which files or directories will be backed up. At step 506 the back-up software either scans the entire hard drive or the selected files. In either case, the software component determines the composite volume of the data the user has decided to back up, which can be in the order of 70 or 80 gigabytes. It also determines an approximate number of 60-minute tapes needed to store the data. This is done to warn the user how many tapes should be at hand for the process. For example, for a 30 gigabyte hard drive back-up, one or two 60-minute DV tapes may be needed. In contrast, backing up the same hard drive using only CD-ROMs would require 45 number of 700 MB disks.

At step 508 the software component checks whether the camcorder is powered by sending it appropriate messages over the FireWire cable. It will also ensure that the camcorder contains a tape. If the camera is not on or a tape is not inserted, the user is prompted. At step 510 the software component performs reliability tests on the tape itself to ensure that there will be data integrity and security on the tape. This can be done using random data and CRCs. In the described embodiment, all possible measures are taken to ensure that the tape will store the data securely and ensure data integrity. In the past, there have been concerns about the reliability of certain types of tapes storing data. For example, the backup/restore software selects a start position on the tape that ensures data integrity.

At step 512 the directory structure representing the data selected to be backed up is transmitted from the software component to the tape. The software component obtains this directory structure information directly from the hard drive on the host computer. As is known in the field, a directory structure is comprised of a series of directory records, i.e., records indicating directory information, and indicates how the data is organized. By backing up the directory structure, data on the tape can be randomly accessed to the extent that compression does not complicate random access. When the data on the hard drive needs to be restored, described below, it is done so using the directory structure.

At step 514 a segment of raw data, for example a data record, from the hard drive is retrieved by the backup/restore software. At step 516 the record of data is received and is processed by the backup/restore software component. For example, the software adds ECCs, CRCs, block headers, and may compress the data. This type of processing of the data is common when preparing data for transmission to ensure data integrity when stored on the tape. Once the segment of data has been processed and encoded at step 516, a next segment or record of data is retrieved from the hard drive. If there is another data record or segment of data, as determined at step 518, control goes to step 520 where the backup/restore software component determines whether the end of the tape has been reached. If the end of the tape has been reached, the user is prompted to insert a new tape at step 522 and control returns to step 510 where the process of storing a segment of data on a new tape is repeated. The integrity of the tape is checked and the directory structure of the data selected for transmission is transmitted from the hard drive to the tape for the same reasons described above.

If the end of the tape has not been reached at step 520, control goes to step 524. At step 518 the back-up/restore software component determines whether there is another data segment from the hard drive. If there are no more data records on the hard drive, control goes to step 524 where the backup/restore software checks if the “verify” option has been set by the user. If “verify” is not set, the process of backing up the data is complete. If “verify” has been set, the software rewinds the tape and checks the data for consistency, for example, using CRCs.

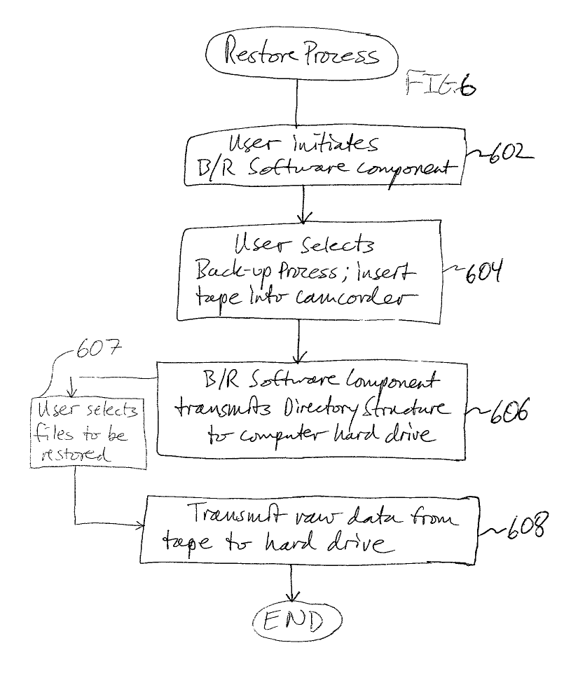

FIG. 6 is a flow diagram of a process for using the backup/restore software component, FireWire, and a DV camcorder to restore data on a computer hard drive in accordance with one embodiment of the present invention. The process of restoring data to a computer hard drive using the software component is relatively simple compared to the backup process. Once the backup process is completed and the backup tapes have been created, restoring the data from the tape to a hard drive requires few steps other than transmitting directory data and actual data.

At step 602 the user initiates the backup/restore software component on the computer to which the data will be restored. A FireWire connection has been established between the computer and the camcorder. At step 604 the user selects the backup process or operation from the software component. At this stage the user has inserted the tape containing the data to be restored to the hard drive. The tape(s) was created during the process described in FIGS. 5A-5C. The process of FIG. 6 will typically occur when there has been some type of data loss or catastrophic failure relating to the computer hard drive. At step 606 the software component causes the transmission of the directory structure of the data to be restored from the tape to the computer hard drive. At step 607 the user selects the files to be restored to the hard drive. This selection is made on the computer and can be done since the directory structure of the data has been transferred to the computer at step 606. The user may choose to select only certain files (many files that were backed up earlier may no longer be of use or may be outdated) or may choose to perform a blanket restore and restore all the files on the tape to the hard drive.

At step 608 the software component causes the transmission of the raw data from the tape to the hard drive. Once all the data from the tape has been transmitted to the hard drive, the software component informs the user that the restore process has been completed at which stage the camcorder can be disconnected from the computer.

In another embodiment, data from a hard drive may be interleaved with AVI video data with regular, non-video data in a way that preserves video data intergrity and also allows nonvideo data to be stored with the video data, if the software component delineates the data. Thus, the current method can be used as a video editing tool that stores edit/update commands directly in the raw footage.

Although the foregoing invention has been described in some detail for purposes of clarity of understanding, it will be apparent that certain changes and modifications may be practiced within the scope of the appended claims. Furthermore, it should be noted that there are alternative ways of implementing both the process and apparatus of the present invention. For example, a USB 2.0 or higher version transmission protocol can be used for data transmission and reception. Known wireless protocols, such as the Wi-Fi standard, can also be used for data transmission and reception. Accordingly, the present embodiments are to be considered as illustrative and not restrictive, and the invention is not to be limited to the details given herein, but may be modified within the scope and equivalents of the appended claims.

What I claim is:

1. A method of backing up data on a storage medium using a digital video camcorder containing a digital tape, the method comprising:
detecting whether a camcorder is connected to a computing device connected to the storage medium, the storage medium containing data to be backed up, wherein the connection is an IEEE-1394 connection;
initiating a backup process by invoking an application on the computing device wherein file directory information is transmitted to the digital tape in the digital video camcorder; and
transmitting data from the computing device to the digital video camcorder.

2. A method as recited in claim 1 wherein the data stored in the storage medium is data of any type.

3. A method as recited in claim 1 wherein the data transferred from the computing device to the digital video camcorder includes data of any type and is not limited to video data.

4. A method as recited in claim 1 wherein the data transferred from the computing device to the digital video camcorder is packaged in a plurality of video frames, wherein a video frame contains digital data of any type.

5. A method as recited in claim 1 wherein the digital video camcorder includes a Digital8 camcorder, a miniDV camcorder, or a DVCAM camcorder.

6. A method as recited in claim 1 wherein the connection is a USB 2.0 connection.

7. A method as recited in claim 1 wherein the digital tape includes a Digital8 tape, a miniDV tape, or a DVCAM tape.

8. A method of transmitting data from a computer hard drive to a storage device, the method comprising:
collecting data on a computer using a back-up software module;
ensuring that a camcorder is on and contains a tape;
processing the data thereby making it suitable for transmission over a IEEE-1394 connection to the camcorder; and
storing the data on the tape in the camcorder.

9. A method of transmitting data from a digital video camcorder to a computer comprising:
retrieving data of any type from a digital tape in the camcorder; and
transmitting the data of any type over an IEEE-1394 connection to a computer.

10. A method as recited in claim 8 further comprising transmitting one or more selected files from the data of any type for transmission over the IEEE-1394 connection to the computer.

11. A method of transmitting data from a DV camcorder to a computer comprising:
retrieving data from a digital tape in the camcorder; and
transmitting the data over a USB connection from the camcorder to a computer.

12. A method of creating a back up of a hard drive in a computer using a digital camcorder containing a digital tape, the method comprising:
connecting the computer to the digital camcorder using a IEEE-1394 connection; and
invoking a back up program on the computer thereby causing data of any type to be transmitted from the hard drive to the digital tape using the IEEE-1394 protocol.

13. A method of restoring a hard drive on a computer using data contained on a digital tape, the method comprising:
connecting the computer to a digital camcorder using an IEEE-1394 connection;
invoking a backup/restore program on the computer;
transmitting data of any type over the IEEE-1394 connection from the digital tape to the hard drive, wherein the data of any type on the tape is back up data for the computer.

14. A method of transmitting data of any type between a digital camcorder and a computing device, the method comprising:
connecting a digital camcorder with a computer;
invoking a backup/restore program on the computer, thereby allowing the computer and the digital camcorder to communicate; and
transmitting data of any variety between the digital camcorder and the computer, wherein the data includes file directory data and is not limited to video data.
